(19) United States
(12) Patent Application Publication
(10) Pub. No.: US 2018/0349587 A1
(43) Pub. Date: Dec. 6, 2018

(54) SECURE CUSTOMIZATION OF ENVIRONMENTAL SETTINGS

(71) Applicant: Mycroft AI Inc., Lawrence, KS (US)

(72) Inventor: Joshua Montgomery, Lawrence, KS (US)

(21) Appl. No.: 15/989,299

(22) Filed: May 25, 2018

Related U.S. Application Data
(60) Provisional application No. 62/512,345, filed on May 30, 2017.

(51) Int. Cl. G06F 21/32; G06F 17/30

(52) U.S. Cl. CPC G06F 21/32; G06F 17/30743

(57) ABSTRACT

Environmental settings and access to a physical space may be secured. An authorized user profile may comprise at least voice information and a plurality of customized environmental settings. The environmental settings may comprise settings appropriate for the space. Spaces such as, but not limited to, a vehicle, an office space, a home, and/or a hotel room may be secured and customized through customized environmental settings. An output device may present a challenge phrase to an individual seeking access to the physical space. An input device may detect a spoken response to the challenge phrase. If the spoken response detected matches both the challenge phrase presented and the voice profile of a user, then the customization settings for that user may be implemented.

### CROSS-REFERENCE TO RELATED APPLICATIONS

This application claims the benefit of U.S. provisional patent application No. 62/512,345, entitled “SECURE CUSTOMIZATION OF ENVIRONMENTAL SETTINGS,” filed on May 30, 2017, and which is incorporated herein by reference.

### FIELD OF INVENTION

The present invention relates to security and customization of environmental settings. More particularly, the present invention relates to the use of voice inputs to control access to a physical space and the customization of environmental settings within the secured space.

### BACKGROUND AND DESCRIPTION OF THE RELATED ART

Advances in computing technology have enabled the temporary customization of a wide variety of physical environments to an individual user's preferences. For example, an automobile may use customization settings of parameters such as a seat position, cabin temperature, radio presets, and the like in association with a person who is anticipated to operate the vehicle. Different people who operate the vehicle may have different customization settings for the vehicle based upon their different physical statures, personal preferences, etc. While individual users may be identified using a particular key or other item that uniquely identifies an individual, for example with an RF transmitter and a unique code, the customization of settings in such an example are incomplete in many ways. First, the customization settings are limited by the number of keys or other items available, as users of the vehicle beyond those associated with one of the pre-determined number of keys will be subjected to someone else's preferences until he or she makes appropriate adjustments. While adjusting the seat or radio station in an automobile may not be a grave obstacle to driving a friend or family member's the vehicle, safety and convenience for a driver are increased when an automobile is customized to a driver's preferences. Further, such adjustments are rendered unnecessary by systems and methods in accordance with the present invention.

### SUMMARY OF THE INVENTION

While described herein in some examples as particularly applicable in the context of an automobile, systems and methods in accordance with the present invention may be useful for a variety of customization uses. For example, the environmental parameters of a home, office, hotel room, or other setting may be securely customized in accordance with the present invention. By way of further example, a computing device (be it a desktop computer, laptop computer, tablet computer, smartphone, a computing system embedded in another device or appliance, or any other type of computing device) may be securely and conveniently customized for the use of more than one individual.

In some examples in accordance with the present invention, a system, such as an automobile, residence, or office, may be secured using systems and methods in accordance with the present invention, with the added benefit beyond security of providing customization options beyond basic access restriction to only authorized individuals. In other examples, access to a system may be controlled all or in part by using other security mechanism or procedures, with systems and methods in accordance with the present invention providing an optional additional layer of security as well as providing customization opportunities for users.

The security limitations of computerized preference settings are a potential vulnerability for many customization protocols. In some instances a nefarious actor attempting to inappropriately access a customization setting may be more annoying than dangerous, for example by changing the radio presets of an automobile to stations that the person associated with the profile in question finds distasteful, but in other instances the inappropriate accessing of a customization profile may be dangerous and may be used as a way to access other systems. Systems and methods in accordance with the present invention enhance the security associated with the implementation of customized user preferences by validating the user prior to implementing the settings. In some examples, systems and methods in accordance with the present invention may recognize a new user and may initiate the creation of preference settings for that new user.

Broadly speaking, systems and methods in accordance with the present invention may require a user to speak a challenge phrase in order to identify the user. Identifying the user enables a system to implement that user's customization settings and may be a prerequisite to the user accessing the system. A challenge phrase may be generated by a computing system and presented to the user seeking to access the system. Challenge phrases may be generated by randomly selecting words from a large library. By matching the voice of the person speaking the challenge phrase to a voiceprint corresponding to a user profile, access to the system may be limited to individuals authorized to use the system. By matching the challenge phrase spoken to the challenge phrase presented, the use of a recording of a previously spoken challenge phrase may be prevented from enabling access to the system. In this way, the secure customization of settings may be attained in accordance with the present invention.

### BRIEF DESCRIPTION OF THE SEVERAL VIEWS OF THE DRAWINGS

Examples of systems and methods in accordance with the present invention are described in conjunction with the attached drawings, wherein:

FIG. 1 illustrates an example of a method in accordance with the present invention; and

FIG. 2 illustrates an example of a system using system in accordance with the present invention.

### DETAILED DESCRIPTION

In some examples, the present invention may comprise a method for the secure customization of environmental settings. The method may comprise the steps of establishing at least one user profile, each of the at least one user profiles comprising a voice profile and environmental customization settings; storing the at least one user profile in a non-transitory form accessible by a computing processing system controlling customizable environmental settings; using an output device under the control of the computing system, prompting an individual seeking to use the environment to verbally respond to a challenge phrase; using an input device under the control of the computing system, receiving a verbal response from the individual seeking to use the environment; within the computing system, determining whether the verbal response matches the challenge phrase presented using the output device and whether the verbal response matches the voice profile associated with one of the at least one user profile; if the verbal response matches the challenge phrase presented using the output device and if the verbal response matches the voice profile associated with one of the at least one user profile, adjusting the environmental settings as indicated by the user profile; and if the verbal response does not match the challenge phrase presented using the output device, denying the individual access to the environment. If the verbal response matches the challenge phrase but the verbal response does not match the voice profile, an exemplary method in accordance with the present invention may further comprise prompting the individual to create a new user profile. Methods in accordance with the present invention may further comprise updating the user profile of the individual based on the spoken challenge phrase (for example, by updating the voice profile associated with the user based on the spoken challenge phrase) and any changes made to customization settings. Examples of customizable environmental settings that may be made using methods in accordance with the present invention are seat positions and/or audio settings in an automobile, light levels and/or thermostat settings in an office and/or hotel room, or any other setting that may be controlled using a computer processor. An output device under the control of the computing system operating in accordance to exemplary methods in accordance with the present invention to prompt an individual seeking to use the environment to verbally respond to a challenge phrase comprises using a display device to present a challenge phrase.

In further examples, the present invention may comprise a system for the secure customization of environmental settings within a physical space. Such and exemplary system may comprise at least one output device capable of producing an output perceivable by an individual seeking to access the physical space; at least one input device capable of receiving a spoken input from the individual seeking to access the physical space; at least one environmental control adjustable to a plurality of settings; and a control unit having at least one computer processor executing computer readable code retained in a non-transitory form that causes the at least one computer processor to perform a method. The method performed may cause the computer processor to access a plurality of user profiles stored in a non-transitory form (each user profile corresponding to an individual, each user profile comprising at least a voice profile for the individual associated with that profile and environmental customization settings selected by that individual), to generate a new challenge phrase when an individual seeks to access the physical space, to present the new challenge phrase to the individual seeking to access the physical space using the output device, to receive a spoken response from the individual seeking to access the physical space using the input device, to compare the spoken response to the new challenge phrase presented using the output device to determine whether the spoken response matches the new challenge phrase, if the spoken response does not match the new challenge phrase to secure the physical space from the individual, if the spoken response does match the new challenge phrase to compare the voice profile of the spoken response to the voice profiles in the user profiles, and if the voice profile of the spoken response matches a voice profile in the user profiles to adjust the at least one environmental control as indicated in the matching user profile. In exemplary systems in accordance with the present invention, the at least one input device may be a microphone, while the at least one output device may be a display or a speaker. Examples of customizable environmental settings that may be made using systems in accordance with the present invention are seat positions and/or audio settings in an automobile, light levels and/or thermostat settings in an office and/or hotel room, or any other setting that may be controlled using a computer processor.

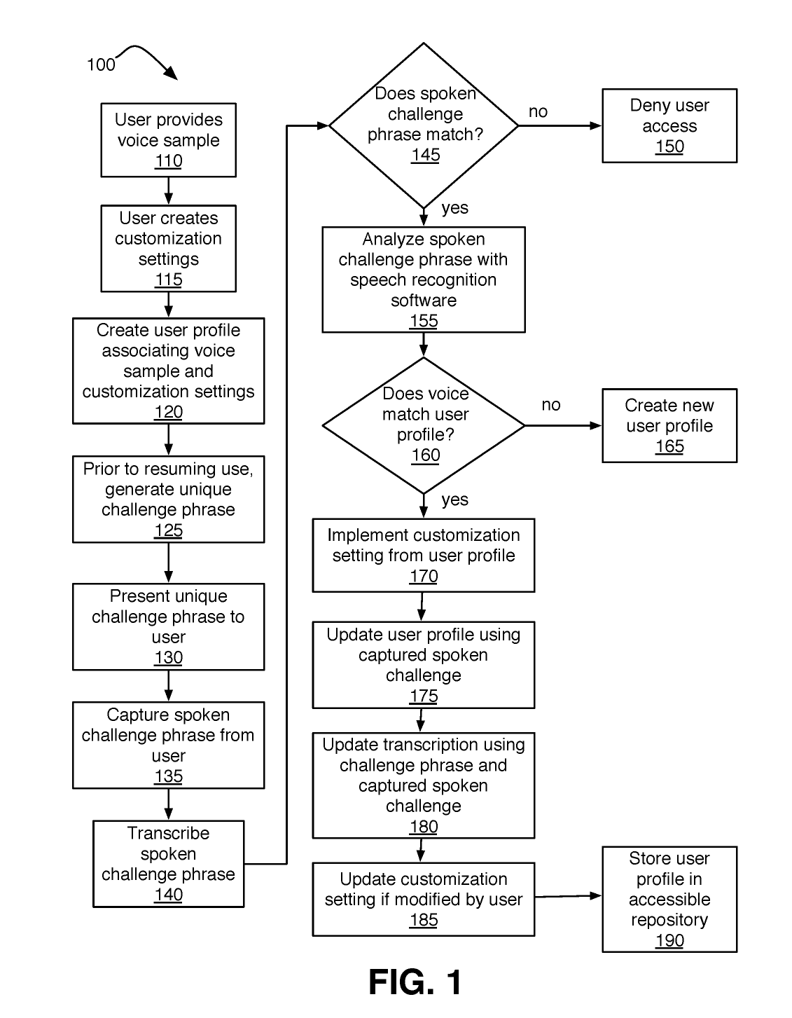

FIG. 1 illustrates one example of a method 100 in accordance with the present invention. Other methods in accordance with the present invention may add steps to the example method 100 illustrated, omit steps from the example method 100 illustrated, and/or re-order steps from what is illustrated in the example method 100.

In step 110, a user may provide a voice sample. A voice sample may be provided, for example, using a script from which a user reads. The voice sample may be obtained using a microphone and digital voice recording algorithms. Software may be used to process the voice sample to identify vocal properties characteristic of the speaker, which may be referred to as a “voiceprint.” The voice sample may be used to uniquely identify a user in the future.

A user may create customization settings in step 115. The customizations created in step 115 may vary based upon the environment being customized. For example, in the case of an automobile, settings may comprise a driver's seat position and configuration, a steering wheel tilt, a cabin temperature, and radio presets. On the other hand, customization settings in an office environment may comprise details such as the amount of illumination provided, the ambient temperature, and whether window coverings are opened or closed. In some examples, systems and methods in accordance with the present invention my primarily or entirely restrict access to a facility or system rather than implement customization settings. In step 120, a user profile may be created by associating the voice sample received in step 110 with the customization settings received in step 115. The user profile may thereafter be used in order to determine which customization settings to apply when a user resumes use of the customizable system.

After a user has created a user profile, a spoken challenge phrase may be used to verify the identity of the user and to implement the appropriate customization settings prior to the user resuming use of the system. In step 125 a unique challenge phrase may be generated. The challenge phrase may be generates 125 by combining two or more words or phrases selected from a long library of options randomly or pseudo-randomly and combining those selections. The challenge phrase may be presented to the user in step 130. The challenge phrase may comprise a few words in the appropriate language spoken by the user. Challenge phrases may be generated by randomly combining two or more words in ways that are unexpected, although in other examples a sufficiently large number of challenge phrases may be predetermined so as to enable a system in accordance with the present invention to cycle through a large number of phrases. The challenge phrase may be presented to a user using a display device (in which case the user must read the challenge phrase) or using an audio device (in which case the user must repeat the challenge phrase). The challenge phrase spoken by the user may be captured by the system in step 135. The spoken challenge phrase may be captured in step 135 using a microphone provided as a part of a system in accordance with the present invention, which may (but need not) be the same microphone used to receive a voice sample in step 110.

In step 140 the challenge phrase spoken and captured in step 135 may be transcribed. Step 140 may use a text-to-speech software stack to create a transcription of the word or words spoken by the user in response to the challenge phrase, although in some examples a speech-to-intent software stack may be used to directly determine whether a user has spoken a presented challenge phrase. In step 145, the transcription produced in step 140 may be compared to the challenge phrase generated in step 125. Comparison step 145 may prevent pre-recorded voice samples from being used to defeat the security of systems and methods in accordance with the present invention, particularly when coupled with randomly generated challenge phrases or a very large number of potential challenge phrases. If the conclusion of step 145 is that the spoken challenge phrase does not match the generated challenge phrase, method 100 may proceed to step 150 to deny the user access to the system. If the conclusion of step 145 is that the spoken challenge phrase does match the challenge phrase generated in step 125, method 100 may proceed.

If the challenge phrases spoken matches the challenge phrase generated, method 100 may proceed to step 155 to analyze the audio recording of the challenge phrase spoken using a speech recognition software stack in step 155. Step 155 may use unique vocal characteristics of a user to match the voice of the user speaking a challenge phrase to a voice sample obtained in step 110. Alternatively, steps 140 and 145 of confirming (or not) that a challenge phrase has been correctly spoken may occur after steps 155 and 160 have matched the voiceprint of a user to a user account. If step 160 does not match the voice speaking the challenge phrase to an existing user profile, method 100 may optionally proceed to step 165 to create a new user profile. In other examples, if step 160 does not match the voice speaking the challenge phrase to an existing user profile, method 160 may deny access to the system. If, on the other hand, step 160 successfully matches the voice captured speaking the challenge phrase with the voice sample associated with a user profile, method 100 may proceed to step 170 to implement the customization settings from the user profile created in step 115.

Optionally, method 100 may proceed to step 175 to update the user profile using the captured spoken challenge phrase. In some examples, machine learning may be used to constantly improve the matching of the voice of a user when speaking a challenge phrase with the voice samples in a user profile. Also optionally, step 180 may update the transcription software stack using the challenge phrase captured in comparison to the generated challenge phrase. Step 180 may utilize machine learning to improve the speech to text transcription of systems in accordance with the present invention. The use of unique challenge phrases, such as is enabled through the random generation of challenge phrases in examples in accordance with the present invention, may enable rapid machine learning to both recognize the voiceprint of a speaker and/or to transcribe speech to text.

Also optionally, step 185 may update customization settings if a user modifies a setting during use. In some examples, a user may designate an adjustment to a setting for saving as an update to a customization setting, while in other examples in accordance with the present invention a user may identify a modification to a setting as a temporary only so as to prevent it from being added to the user profile.

Method 100 may optionally proceed to step 190 to store the user profile in an accessible repository. In some examples in accordance with the present invention, a repository of the customization settings and the corresponding user voice profile may be retained within the system, such as an automobile, where the customizations are to be implemented. In other examples, however, a customization profile may be stored to a repository so as to permit the portability of those customization settings and the corresponding voiceprints. For example, the user profile used in method 100 may be stored in a repository contained on a smart phone or other storage and/or computing device that may be readily carried by a user. In other examples, a repository may comprise a remote server or other computing device accessible over one or more network. The contents of a user profile may be transmitted to a repository via a wired connection and/or wireless connection and over one or more network. In examples of a remote repository, a repository may be proprietary for a single entity (such as an automobile manufacturer), but a repository may be shared by a number of companies, individuals or entities and may be used for a variety of purposes (such as to customize home environments, automobiles, hotel rooms, etc.) while combining the power of voice authentication. By providing a repository such as in the example of step 190, a user profile may be transported from one system to another. For example, if the customization settings are for an automobile, a user may transfer his or her customization settings to a new automobile using systems and methods in accordance with the present invention. By way of further example, if the customization settings relate to a home or office setting, a user may readily work in an ever changing office location, such as occurs in some co-working spaces, or may quickly adapt a hotel room to his or her preferences using a repository and systems and methods in accordance with the present invention.

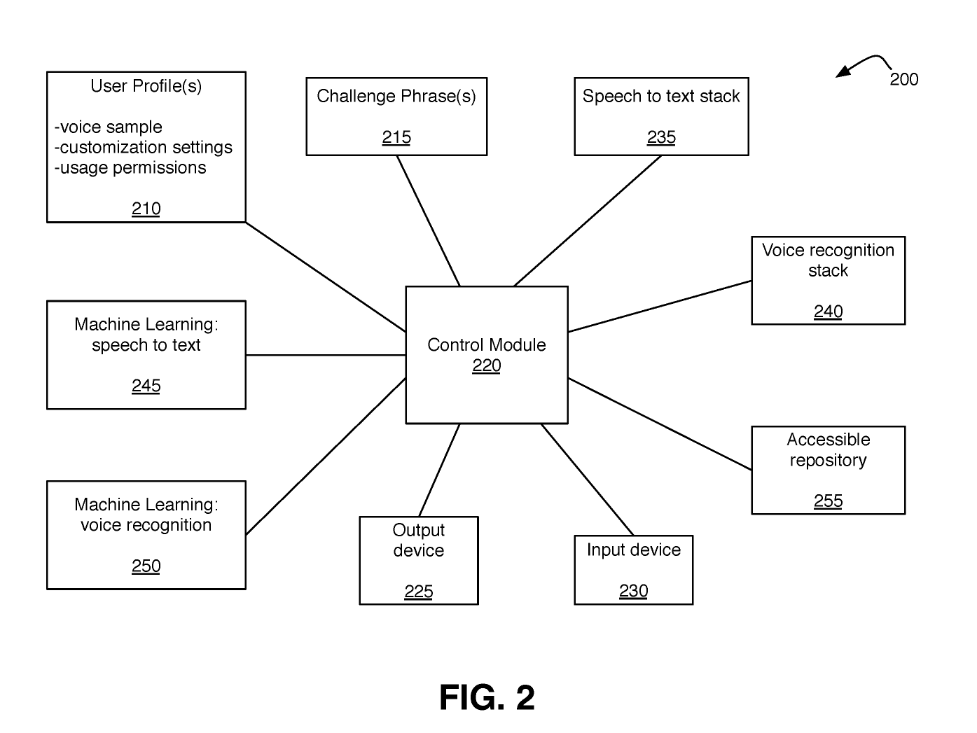

Referring now to FIG. 2, an example of a system 200 in accordance with the present invention is illustrated. A control module 220 may comprise a computer processor executing computer readable code to cause a system controlled at least in part by the computer processor to perform in accordance with methods of the present invention. The control module 220 may comprise a single discrete unit or a distributed processor system within a single device or multiple devices. The computer readable code executed by a computer processor may be retained in a non-transitory form either within, in conjunction with or accessible by the control module 220. The control module may receive inputs from at least one input device 230. An input device 230 may comprise, for example, a microphone that receives and captures speech from a user. Additional input devices that may optionally be provided in systems in accordance with the present invention are keyboards, touch sensitive screens, pointing devices such as a computer mouse or trackpad, buttons, pedals, motion detectors, motion capture systems, and/or any other mechanism that may be used to register an input. Systems in accordance with the present invention are not limited to any particular number or variety of input devices 230. System 200 may further provide an output device 225. An output device may comprise, for example, a display or screen that you may provide in a text form a challenge phrase for a script to be read by a user. In other examples, an output device 225 may comprise one or more audio speaker that provides sound, such as a computer synthesized recitation of the challenge phrase, that may be heard by a user. Systems in accordance with the present invention are not limited to any particular number or variety of output devices 225.

System 200 may further provide user profiles 210. User profiles 210 may be retained in a digital form stored in a computer readable memory. A user profile may reside within the system to be customized, such as an automobile, and/or may reside in a repository that does not necessarily reside within the system to be customized. A user profile may contain, for example, at least one of voice sample of the user or data descriptive of the voice of the user, customization settings, and usage permissions. Usage permissions may be particularly useful in circumstances such as in a family where one or more member is a minor and has partial but limited access to an automobile or other facility. By setting usage permissions in such a case, a parent may place additional controls for the safety and well being of the juvenile user, such as limitations on stereo volume.

System 200 may further provide a challenge phrase generator 215. In some examples, a challenge phrase generator 215 may comprise a list of challenge phrases, but in other examples in order to increase the security of the system 200 challenge phrase generator 215 may randomly combine two or more words to be spoken by a user. In the example of a challenge phrase generator 215 that generates challenge phrases by combining words, those words may be selected randomly or pseudo-randomly from lengthy dictionary lists or libraries, providing a high degree of randomness for the resulting challenge phrases and, therefore, a high degree of security for the system to be customized.

System 200 may further comprise a speech-to-text software stack 235. In some examples, speech-to-text software stack 235 may be replaced or augmented by a speech-to-intent software stack. The speech-to-text software stack 235 may transcribe audible speech captured by an input device (such as a microphone) into text. The speech-to-text software stack 235 may provide a transcription of a spoken challenge phrase to a control module 220, which may compare the transcription to the challenge phrase generated by the challenge phrase generator 215 to determine whether a user has correctly spoken a presented challenge phrase. If a spoken challenge phrase does not correspond to a generated challenge phrase, systems in accordance with the present invention may provide additional opportunities to correctly speak a challenge phrase and/or may provide an override mechanism, such as the entry of a password or the answering of challenge questions known only to an individual user. In some examples, the inability of a user to correctly speak a challenge phrase may be taken as an indication that a recording of a user's voice has been used in an attempt to circumvent the security of the system 200 and, therefore, access to the system may be denied.

A voice recognition software stack 240 may receive a spoken challenge phrase captured by an input device (such as a microphone) and compare the speech to the voice sample(s) in one or more user profile. The voice recognition stack 240 may permit control module 220 to determine whether the voice speaking the challenge phrase matches the voice sample of a user profile. If a correct challenge phrase is spoken by a voice matching a user profile is detected, the proper customization settings and, if provided, usage permissions may be implemented for the user in question. An accessible repository 255 may also receive some or all information from a user profile 210 to permit the easy transport and/or reimplementation of those settings at a different system. The accessible repository 255 may comprise a smart phone or other mobile device provided by a user, but may additionally/alternatively comprise a remote computing device or server that receives all or part of a user profile over one or more network, stores the user profile, and provides a user access to the user profile at a later date and/or for a different system.

In some examples, a system 200 may further comprise a machine learning module for speech-to-text transcription 245. The speech-to-text machine learning module 245 may continuously improve the performance of the speech-to-text software stack 235 as a user speaks additional challenge phrases in order to use system 200. In this fashion, the reliably accurate transcription of spoken words may be improved through use.

A system 200 may further optionally provide a machine learning module for the voice recognition stack 250. The voice recognition machine learning module 250 may continuously improve the performance of the voice recognition software stack 240 such that as a user provides additional spoken challenge phrases, and optionally additional voice samples, the matching of that user's voice to voice samples contained within a user profile may be improved.

While described in conjunction with some specific examples herein, the present invention is not limited to any specific environment or system. For example, a system or method in accordance with the present invention may be implemented as part of an automobile, an office, a home, or any other environment where individuals desire secure authentication and/or customization of a system or facility. For example, systems and methods in accordance with the present invention may be used to conveniently but securely access a garage door opener from outside of a user's garage. Rather than requiring a token or transmitter to initiate opening (or other access of various other facilities or systems), a user's voice itself may comprise a token. In some examples in accordance with the present invention, other biometric characteristics of an individual (fingerprints, retinal scans, etc.) may be used as a token in addition to or instead of the voice print of a user. Systems and methods in accordance with the present invention may be implemented on a variety of computing platforms using a variety of interfaces.

Further, the systems customized using systems and methods in accordance with the present invention may vary, as may the mechanisms whereby a user's customization preferences are implemented. For example, some customizations may require only digital modifications, such as mapping a radio preset button to a different radio frequency, while other customizations may require activating a motor or servo to move a seat. Different types of systems that are customized using systems and methods in accordance with the present invention may require different types of actions to implement customization setting corresponding to a user identified as matching a corresponding user profile; for example, implementing customization settings for an office requires different adjustments than implementing customization settings for an automobile. The present invention is not limited to any particular system or environment that is customized in response to matching a user's voiceprint and challenge phrase to access a system in accordance with the present invention.

1. A method for the secure customization of environmental settings, the method comprising:
establishing at least one user profile, each of the at least one user profiles comprising a voice profile and environmental customization settings;
storing the at least one user profile in a non-transitory form accessible by a computing processing system controlling customizable environmental settings;
using an output device under the control of the computing system, prompting an individual seeking to use the environment to verbally respond to a challenge phrase;
using an input device under the control of the computing system, receiving a verbal response from the individual seeking to use the environment;
within the computing system, determining whether the verbal response matches the challenge phrase presented using the output device and whether the verbal response matches the voice profile associated with one of the at least one user profile;
if the verbal response matches the challenge phrase presented using the output device and if the verbal response matches the voice profile associated with one of the at least one user profile, adjusting the environmental settings as indicated by the user profile; and
if the verbal response does not match the challenge phrase presented using the output device, denying the individual access to the environment.

2. The method for the secure customization of environmental settings of claim 1, further comprising, if the verbal response matches the challenge phrase but the verbal response does not match the voice profile, prompting the individual to create a new user profile.

3. The method for the secure customization of environmental settings of claim 1, further comprising updating the user profile of the individual based on the spoken challenge phrase and any changes made to customization settings.

4. The method for the secure customization of environmental settings of claim 3, wherein updating the user profile of the individual based on the spoken challenge phrase further comprises updating the voice profile associated with the user based on the spoken challenge phrase.

5. The method for the secure customization of environmental settings of claim 4, wherein the customizable environmental settings comprise at least a seat position in an automobile.

6. The method for the secure customization of environmental settings of claim 4, wherein the customizable environmental settings comprise at least a seat position and audio settings in an automobile.

7. The method for the secure customization of environmental settings of 4, wherein the customizable environmental settings comprise at least a light level in an office.

8. The method for the secure customization of environmental settings of claim 1, wherein using an output device under the control of the computing system to prompt an individual seeking to use the environment to verbally respond to a challenge phrase comprises using a display device to present a challenge phrase.

9. A system for the secure customization of environmental settings within a physical space, the system comprising:
at least one output device capable of producing an output perceivable by an individual seeking to access the physical space;
at least one input device capable of receiving a spoken input from the individual seeking to access the physical space;
at least one environmental control adjustable to a plurality of settings; and
a control unit, the control unit comprising at least one computer processor executing computer readable code retained in a non-transitory form that causes the at least one computer processor to:
access a plurality of user profiles stored in a non-transitory form, the plurality of user profiles, each user profile corresponding to an individual, each user profile comprising at least a voice profile for the individual associated with that profile and environmental customization settings selected by that individual,
generate a new challenge phrase when an individual seeks to access the physical space,
present the new challenge phrase to the individual seeking to access the physical space using the output device,
receive a spoken response from the individual seeking to access the physical space using the input device,
compare the spoken response to the new challenge phrase presented using the output device to determine whether the spoken response matches the new challenge phrase,
if the spoken response does not match the new challenge phrase, to secure the physical space from the individual,
if the spoken response does match the new challenge phrase, comparing the voice profile of the spoken response to the voice profiles in the user profiles and, if the voice profile of the spoken response matches a voice profile in the user profiles, adjusting the at least one environmental control as indicated in the matching user profile.

10. The system for the secure customization of environmental settings within a physical space of claim 9, wherein the at least one input device comprises a microphone.

11. The system for the secure customization of environmental settings within a physical space of claim 9, wherein the at least one output device comprises a display.

12. The system for the secure customization of environmental settings within a physical space of claim 9, wherein the at least one output device comprises a speaker.

13. The system for the secure customization of environmental settings within a physical space of claim 9, wherein the environmental customization settings comprise at least a thermostat temperature.

14. The system for the secure customization of environmental settings within a physical space of claim 9, wherein the environmental customization settings comprise at least an ambient light setting.
